(19) United States
(12) Patent Application Publication
(10) Pub. No.: US 2014/0063683 A1
(43) Pub. Date: Mar. 6, 2014

(54) CONDUCTIVE PASTE FOR EXTERNAL ELECTRODE, MULTILAYER CERAMIC ELECTRONIC COMPONENT MANUFACTURED BY USING THE SAME AND MANUFACTURING METHOD THEREOF

(71) Applicant: SAMSUNG ELECTRO-MECHANICS CO., LTD., Suwon-si (KR)

(72) Inventors: Hyun Hee GU, Suwon-si (KR); Sung Koo KANG, Suwon-si (KR); Kyung Pyo HONG, Suwon-si (KR); Byung Jun JEON, Suwon-si (KR)

(73) Assignee: SAMSUNG ELECTRO-MECHANICS CO., LTD., Suwon-si (KR)

(21) Appl. No.: 13/707,309

(22) Filed: Dec. 6, 2012

(30) Foreign Application Priority Data
Sep. 6, 2012 (KR) 10-2012-0099007

(51) Int. Cl. H01G 4/30

(52) U.S. Cl. CPC H01G 4/30
USPC 361/301.4; 252/512; 427/79

(57) ABSTRACT

There are provided a conductive paste for an external electrode including: 100 parts by weight of a conductive metal particle; 5 to 30 parts by weight of a base resin; and 0.5 to 10 parts by weight of a spherical cross-linked polymer.

### CROSS-REFERENCE TO RELATED APPLICATIONS

This application claims the priority of Korean Patent Application No. 10-2012-0099007 filed on Sep. 6, 2012, in the Korean Intellectual Property Office, the disclosure of which is incorporated herein by reference.

### BACKGROUND OF THE INVENTION

1. Field of the Invention

The present invention relates to a conductive paste for an external electrode capable of improving bending strength characteristics of a multilayer ceramic electronic component, a multilayer ceramic electronic component manufactured by using the same, and a manufacturing method thereof.

2. Description of the Related Art

Among ceramic electronic components, a multilayer ceramic capacitor (MLCC) includes a plurality of laminated dielectric layers, internal electrodes disposed to face each other, while having each dielectric layer interposed therebetween, and external electrodes electrically connected to the internal electrodes.

An MLCC is commonly used as a component in mobile communication devices such as computers, PDAs (Personal Digital Assistants), portable phones, and the like, due to advantages of being small, guaranteeing high capacity, and being easily mounted.

Recently, as electronic products have been reduced in size and have developed multifunctionality, chip components have also become compact and highly functional, and thus, a multilayer ceramic capacitor (MLCC) which is small but has a high capacity is in demand.

To this end, an MLCC has been fabricated by reducing the thickness of dielectric layers and inner electrode layers and laminating a larger number thereof, and external electrodes have also been reduced in thickness.

Also, as multiple appliances and devices requiring high reliability in a wide range of fields, such as automobiles, medical appliances, and the like, have become electronic and demand therefor has increased, an MLCC has been required to have a high degree of reliability.

A factor that may be problematic in terms of realizing high reliability may be a generation of cracks, and the like, due to external impacts, and as a solution, a resin composition containing a conductive material may be applied between an electrode layer and a plating layer of an external electrode to absorb external impacts and prevent an infiltration of a plating solution, thus enhancing reliability.

However, in order to be applied to product groups having specific specifications, such as electric apparatuses or electric frames and high voltage products, a multilayer ceramic electronic component having a level of reliability higher than a current level thereof is required, and thus, an external electrode is also required to have bending strength characteristics higher than a current level thereof.

### RELATED ART DOCUMENT

(Patent Document 1) Japanese Patent Laid Open Publication No. 2002-367859

### SUMMARY OF THE INVENTION

An aspect of the present invention provides a conductive paste for an external electrode capable of improving bending strength characteristics of a multilayer ceramic electronic component, a multilayer ceramic electronic component manufactured by using the same, and a fabricating method thereof.

According to an aspect of the present invention, there is provided a conductive paste for an external electrode, including: 100 parts by weight of a conductive metal particle; 5 to 30 parts by weight of a base resin; and 0.5 to 10 parts by weight of a spherical cross-linked polymer.

The spherical cross-linked polymer may have an average particle diameter ranging from 0.05 μm to 50 μm.

The spherical cross-linked polymer may have elasticity and heat resistance at 250° C. or higher, and may include one or more selected from the group consisting of rubber, polysterene, acryl, silicon, and epoxy.

The conductive metal particle may include one or more selected from a group consisting of copper (Cu), nickel (Ni), silver (Ag), and silver-palladium (Ag—Pd).

According to another aspect of the present invention, there is provided a multilayer ceramic electronic component including: a ceramic body including a dielectric layer; first and second internal electrodes disposed to face each other within the ceramic body, while having the dielectric layer interposed therebetween; a first electrode layer electrically connected to the first internal electrode and a second electrode layer electrically connected to the second internal electrode; and a first conductive resin layer formed on the first electrode layer, and a second conductive resin layer formed on the second electrode layer, wherein the first and second conductive resin layers may include 100 parts by weight of a conductive metal particle; 5 to 30 parts by weight of a base resin; and 0.5 to 10 parts by weight of a spherical cross-linked polymer.

The spherical cross-linked polymer may have an average particle diameter ranging from 0.05 μm to 50 μm.

The spherical cross-linked polymer has an average particle diameter ranging from 0.05 μm to a distance equal to half of a thickness of the respective conductive resin layers, and the thickness of the respective conductive resin layers may range from 3 μm to 100 μm.

The spherical cross-linked polymer may have elasticity and heat resistance at 250° C. or higher, and may include one or more selected from the group consisting of rubber, polysterene, acryl, silicon, and epoxy.

The conductive metal particle may include one or more selected from a group consisting of copper (Cu), nickel (Ni), silver (Ag), and silver-palladium (Ag—Pd).

According to another aspect of the present invention, there is provided a multilayer ceramic electronic component including: a ceramic body including a dielectric layer and internal electrodes; electrode layers electrically connected to the internal electrodes; and conductive resin layers formed on the electrode layers, respectively, and including 100 parts by weight of a conductive metal particle; 5 to 30 parts by weight of a base resin; and 0.5 to 10 parts by weight of a spherical cross-linked polymer, wherein the spherical cross-linked polymer may have an average particle diameter ranging from 0.05 μm to a distance equal to half of a thickness of the respective conductive resin layers, and the thickness of the respective conductive resin layers ranges from 3 μm to 100 μm.

According to another aspect of the present invention, there is provided a method of manufacturing a multilayer ceramic electronic component, the method including: preparing a ceramic body including a dielectric layer and first and second internal electrodes disposed to face each other, while having the dielectric layer interposed therebetween; forming first and second electrode layers such that the first and second electrode layers are electrically connected to the first and second internal electrodes; hardening a crosslinkable material to prepare a spherical cross-linked polymer; mixing 100 parts by weight of a conductive metal particle; 5 to 30 parts by weight of a base resin; and 0.5 to 10 parts by weight of a spherical cross-linked polymer to prepare a conductive paste for an external electrode; and applying the conductive paste for an external electrode to the first and second electrode layers and hardening the paste to form first and second conductive resin layers.

The spherical cross-linked polymer may have an average particle diameter ranging from 0.05 μm to 50 μm, and may have heat resistance at a temperature of 250° C. or higher.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a scanning electron microscope (SEM) photograph showing a fine structure of a paste for an external electrode according to an embodiment of the present invention;

FIG. 2 is a perspective view schematically illustrating a multilayer ceramic capacitor according to an embodiment of the present invention;

FIG. 3 is a cross-sectional view taken along line A-A′ of FIG. 1, according to the embodiment of the present invention; and

FIG. 4 is a graph showing experimental results of a comparison between detected defective capacity changes depending on the depth of bending cracks of the multilayer ceramic capacitor of the embodiment of the present invention and a multilayer ceramic capacitor according to a comparative example.

### DETAILED DESCRIPTION OF THE EMBODIMENTS

Hereinafter, embodiments of the present invention will be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the shapes and dimensions of elements may be exaggerated for clarity, and the same reference numerals will be used throughout to designate the same or like elements.

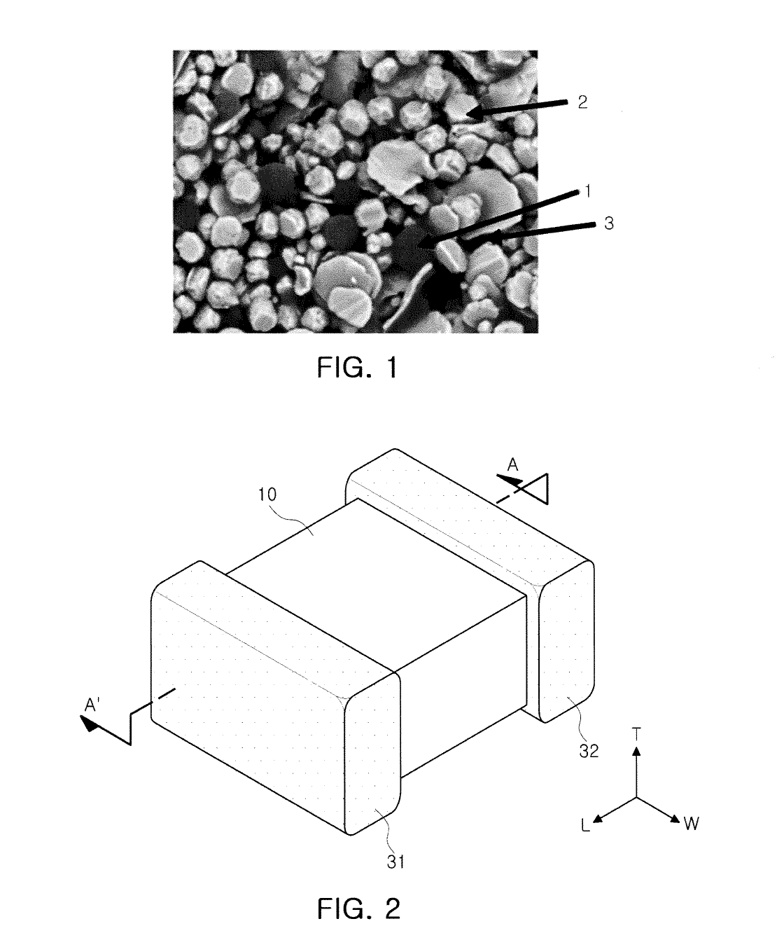

FIG. 1 is a scanning electron microscope (SEM) photograph showing a fine structure of a paste for an external electrode according to an embodiment of the present invention.

A conductive paste for an external electrode according to an embodiment of the present invention may include: a conductive metal particle 2; a base resin 3; and a spherical cross-linked polymer 1, wherein 5 to 30 parts by weight of the base resin 3 and 0.5 to 10 parts by weight of the spherical cross-linked polymer 1 may be included over 100 parts by weight of the conductive metal particle 2.

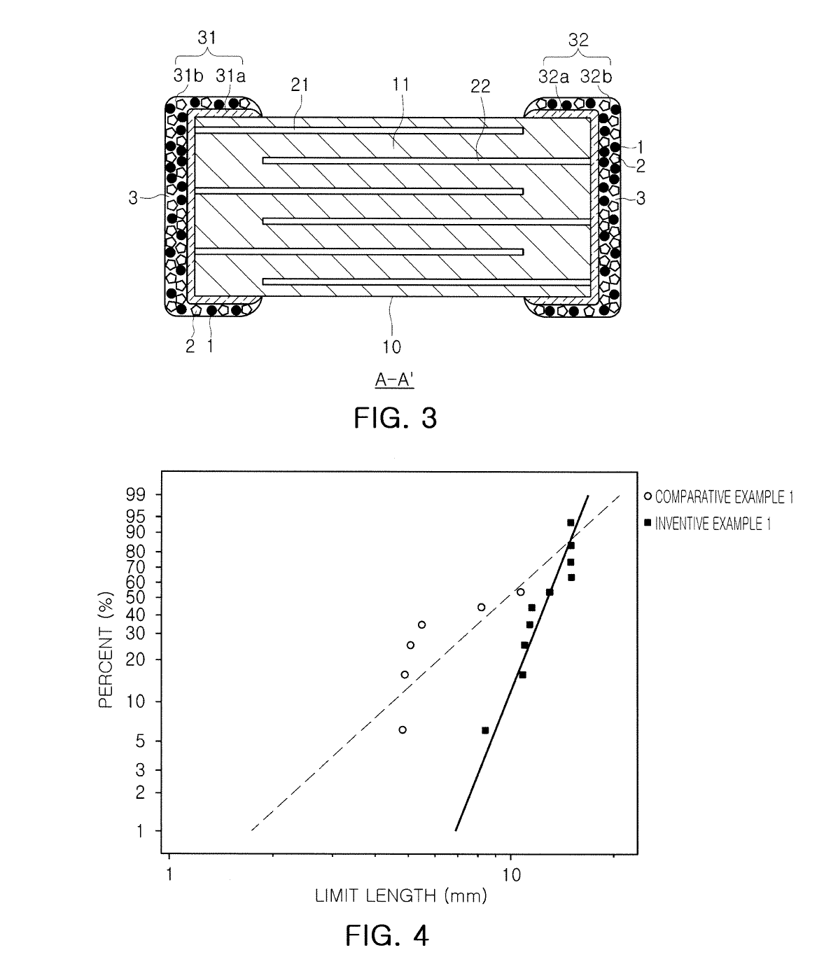

FIG. 2 is a perspective view schematically illustrating a multilayer ceramic capacitor according to an embodiment of the present invention; and FIG. 3 is a cross-sectional view taken along line A-A′ of FIG. 1, according to the embodiment of the present invention.

A multilayer ceramic electronic component according to an embodiment of the present invention may include a ceramic body 10 including a dielectric layer 11; first and second internal electrodes 21 and 22 disposed to face each other within the ceramic body 10, while having the dielectric layer 11 interposed therebetween; a first electrode layer 31a electrically connected to the first internal electrode 21 and a second electrode layer 32a electrically connected to the second internal electrode 22; and a first conductive resin layer 31b formed on the first electrode layer 31a and a second conductive resin layer 32b formed on the second electrode layer 32a, wherein the first and second conductive resin layers 31b and 32b include 100 parts by weight of the conductive metal particle 2, 5 to 30 parts by weight of the base resin 3, and 0.5 to 10 parts by weight of the spherical cross-linked polymer 1.

The first and second conductive resin layers 31b and 32b are formed by using the conductive paste for an external electrode according to an embodiment of the present invention, which will be described hereinafter.

The base resin 3 is not particularly limited, as long as the base resin has bonding properties and impact absorbing characteristics and may be mixed with the conductive metal particle 2 to create a paste. For example, the base resin 3 may include an epoxy resin.

If the content of the base resin 3 is less than 5 parts by weight, it is difficult to prepare a paste due to shortage of the resin, phase stability is degraded to cause phase separation and time-dependent changes in viscosity, and metal dispersibility is degraded to reduce a filling ratio thereby degrading compactness. If the content of the base resin 3 exceeds 30 parts by weight, the content of the resin may be excessive, thereby degrading inter-metal contact characteristics to increase specific resistance, and since a resin area of a surface part is increased to cause non-plating problems in forming a plating layer after the conductive resin layers 31b and 32b are formed.

If the content of the spherical cross-linked polymer 1 is less than 0.5 parts by weight, the effect of improving bending crack characteristics is not exhibited, and if the content of the spherical cross-linked polymer 1 exceeds 10 parts by weight, non-plating deficiency or a degradation of adhesion strength may be shown when a plating layer is formed on the conductive resin layers 31b and 32b.

An average particle diameter of the spherical cross-linked polymer 1 may range from 0.05 μm to 50 μm. When a cross-linked polymer is synthesized to have a spherical shape, nano-scale particles can easily be prepared. If the average particle diameter of the spherical cross-linked polymer 1 is less than 0.05 μm, a particle size thereof is too small to sufficiently absorb impacts, while if the average particle diameter of the spherical cross-linked polymer 1 exceeds 50 μm, necking of the conductive metal particle 2 included in the conductive resin layers 31b and 32b is interrupted, thereby resulting in a failure of security conductivity or causing non-plating.

In more detail, an average particle diameter of the spherical cross-linked polymer 1 may range from 0.05 μm to a distance equal to half of a thickness of the respective conductive resin layers 31b and 32b, and the thickness of the respective conductive resin layers 31b and 32b may range from 3 μm to 100 μm. If the average particle diameter of the spherical cross-linked polymer 1 exceeds half of the thickness of the respective conductive resin layers 31b and 32b, non-plating deficiency occurs when a plating layer is formed on the conductive resin layers 31b and 32b.

The spherical cross-linked polymer 1 may be made of a material having elasticity and heat resistance at a temperature of 250° C. or higher. In particular, since the conductive resin layers 31b and 32b are formed through a heat treatment after the conductive paste is applied, the spherical cross-linked polymer 1 is required to have heat resistance at high temperatures. The spherical cross-linked polymer 1 may include one or more selected from the group consisting of rubber, polysterene, acryl, silicon, and epoxy, but the present invention is not limited thereto.

The conductive metal particle 2 may include one or more selected from the group consisting of copper (Cu), nickel (Ni), silver (Ag), and silver-palladium (Ag—Pd), but the present invention is not limited thereto.

A raw material for forming the dielectric layer 11 is not particularly limited as long as sufficient capacitance is obtained through the use thereof. For example, the raw material may be a powder such as a barium titanate (BaTiO₃) powder. Also, for the material of the dielectric layer 11, various materials such as a ceramic additive, an organic solvent, a plasticizer, a bonding agent, a dispersing agent, or the like, may be added to the powder such as the barium titanate (BaTiO₃) powder, or the like, according to the purpose of the present invention.

A material for forming the internal electrodes 21 and 22 is not particularly limited. For example, the internal electrodes 21 and 22 may include one or more of silver (Ag), lead (Pb), platinum (Pt), nickel (Ni), and copper (Cu).

A material used to form the first and second electrode layers 31a and 32a is not particularly limited as long as the electrode layers may be electrically connected to the internal electrodes 21 and 22. For example, the material may be one or more selected from the group consisting of copper (Cu), nickel (Ni), silver (Ag), and silver-palladium (Ag—Pd).

Another embodiment of the present invention provides a multilayer ceramic electronic component including: the ceramic body 10 including the dielectric layer 11 and the internal electrodes 21 and 22; the electrode layers 31a and 32a electrically connected to the internal electrodes 21 and 22; and the conductive resin layers 31b and 32b formed on the electrode layers 31a and 32a, respectively, and including 100 parts by weight of the conductive metal particle 2, 5 to 30 parts by weight of the base resin 3 and 0.5 to 10 parts by weight of the spherical cross-linked polymer 1, wherein the average particle diameter of the spherical cross-linked polymer 1 ranges from 0.05 μm to the distance equal to half of the thickness of the respective conductive resin layers 31b and 32b, and the thickness of the respective conductive resin layers 31b and 32b ranges from 3 μm to 100 μm.

Another embodiment of the present invention provides a method of manufacturing a multilayer ceramic electronic component, the method including: preparing the ceramic body 10 including the dielectric layer 11 and the first and second internal electrodes 21 and 22 disposed to face each other, while having the dielectric layer 11 interposed therebetween; forming the first and second electrode layers 31a and 32a such that the first and second electrode layers 31a and 32a are electrically connected to the first and second internal electrodes 21 and 22; hardening a crosslinkable material to prepare the spherical cross-linked polymer 1; mixing 100 parts by weight of the conductive metal particle 2, 5 to 30 parts by weight of the base resin 3 and 0.5 to 10 parts by weight of the spherical cross-linked polymer 1 to prepare the conductive paste for an external electrode; and applying the conductive paste for an external electrode to the first and second electrode layers 31a and 32a and hardening the conductive paste to form the first and second conductive resin layers 31b and 32b.

A description regarding characteristics of the method of manufacturing a multilayer ceramic electronic component is the same as the description of the multilayer ceramic capacitor according to the embodiment of the present invention, thus it will be omitted.

Table 1 below shows results obtained by evaluating characteristics of the multilayer ceramic electronic component while changing the content of the spherical cross-linked polymer 1 included in the conductive resin layers 31b and 32b of the multilayer ceramic electronic component. The conductive resin layers 31b and 32b include 100 parts by weight of the conductive metal particle 2 (copper: Cu) and 13 parts by weight of an epoxy resin, in addition to the spherical cross-linked polymer 1. Bending strength characteristics were obtained by measuring the number of multilayer ceramic electronic components having cracks when the respective multilayer ceramic electronic components in which different contents of the spherical cross-linked polymer 1 are included, were bent by 5 mm, and plating characteristics was based on the observation of the number of multilayer ceramic electronic components having a non-plated area of 5% or more in forming Ni plating layers (electroplating 1 hr) on the conductive resin layers 31b and 32b.

TABLE 1

| Content of spherical | Bending strength | Plating |
|---|---|---|
| cross-linked polymer | characteristics | characteristics |
| (parts by weight of | (number of defective | (number of non-plated |
| spherical cross-linked | components/total | defective components/ |
| polymer over 100 parts | number of | total number of |
| by weigh of copper (Cu)) | components) | components) |
| 0.05* | 2/20 | 0/100 |
| 0.1* | 3/20 | 0/100 |
| 0.3* | 2/20 | 0/100 |
| 5 | 0/20 | 0/100 |
| 1 | 0/20 | 0/100 |
| 3 | 0/20 | 0/100 |
| 5 | 0/20 | 0/100 |
| 7 | 0/20 | 0/100 |
| 10 | 0/20 | 0/100 |
| 12* | 0/20 | 6/100 |
| 15* | 0/20 | 17/100 |
| 20* | 0/20 | 34/100 |

(*indicates comparative examples)

Referring to Table 1, it can be seen that, when the spherical cross-linked polymer 1 is included in an amount of less than 0.5 parts by weight, defective bending crack occurred, and when the spherical cross-linked polymer 1 is included in an amount exceeding 10 parts by weight, non-plating defects occurred. Thus, it is preferred that the spherical cross-linked polymer 1 is included in an amount of 0.5 to 10 parts by weight in the paste for an external electrode or the conductive resin layers 31b and 32b.

Table 2 and 3 below show results obtained by evaluating the characteristics of multilayered ceramic electronic components according to thicknesses of the conductive resin layers 31b and 32b and average particle diameters of the spherical cross-linked polymer 1 included in the conductive resin layers 31b and 32b. Bending strength characteristics and plating characteristics were evaluated under the same conditions as above, and it was determined that plating characteristics is bad when non-plated area is 5% or more. In the multilayer ceramic electronic components used in this evaluation, the conductive resin layers 31b and 32b includes 100 parts by weight of the conductive metal particle 2 (Cu), 13 parts by weight of an epoxy resin, and 1.5 parts by weight of the spherical cross-linked polymer 1.

TABLE 2

| | | Bending strength | |
|---|---|---|---|
| Thickness of | Size of | characteristics | Plating |
| conductive | spherical | (number of defective | charac- |
| resin | cross-linked | components/total | teristics |
| layer (μm) | polymer (μm) | number of components) | (good or bad) |
| 3 | 0.1 | 0/20 | good |
| 3 | 0.5 | 0/20 | good |
| 3 | 1 | 0/20 | good |
| 3 | 1.5 | 0/20 | good |
| 3* | 2.5 | 0/20 | bad |
| 10 | 0.1 | 0/20 | good |
| 10 | 2.5 | 0/20 | good |
| 10 | 5 | 0/20 | good |
| 10* | 7 | 0/20 | bad |
| 10* | 10 | 0/20 | bad |

(*indicate comparative examples)

TABLE 3

| | | Bending strength | |
|---|---|---|---|
| Thickness of | Size of | characteristics | Plating |
| conductive | spherical | (number of defective | charac- |
| resin | cross-linked | components/total | teristics |
| layer (μm) | polymer (μm) | number of components) | (good or bad) |
| 30 | | 0/20 | good |
| 30 | | 0/20 | good |
| 30 | | 0/20 | good |
| 30* | | 0/20 | bad |
| 30* | | 0/20 | bad |
| 50 | | 0/20 | good |
| 50 | | 0/20 | good |
| 50 | | 0/20 | good |
| 50* | | 0/20 | bad |
| 50* | | 0/20 | bad |
| 100 | | 0/20 | good |
| 100 | | 0/20 | good |
| 100 | | 0/20 | good |
| 100 | | 0/20 | good |
| 100* | | 0/20 | bad |

(*indicate comparative examples)

Based on Table 2 and Table 3, it can be seen that, in the experimental range, bending strength characteristics appeared to be good irrespective of the size of the spherical cross-linked polymer 1. In this case, however, when the size of the spherical cross-linked polymer 1 exceeds a distance equal to the half of the thickness of the respective conductive resin layers 31b and 32b, it can be confirmed that plating characteristics were bad. Thus, it is preferred that the spherical cross-linked polymer 1 is included in an amount equal to or smaller than half of the thickness of the respective conductive resin layers 31b and 32b.

Table 4 below show the number of multilayer ceramic electronic components having capacity lowered due to a generation of cracks while a degree of bending was continuously changed up to 5 mm, among multilayered ceramic electronic components using a conductive resin layer including 100 parts by weight of the conductive metal particle 2 and 13 parts by weight of an epoxy resin (hereinafter, referred to as Comparative Example 1) and multilayer ceramic electronic components using a conductive resin layer including 100 parts by weight of the conductive metal particle 2, 13 parts by weight of an epoxy resin, and 1.5 parts by weight of the spherical cross-linked polymer 1 (hereinafter, referred to as Inventive Example 1).

TABLE 4

| Classification | Inventive Example 1 | Comparative Example 1 |
|---|---|---|
| Number of components | 0/10 | 0/10 |
| having degraded | | |
| capacity (3 mm bend) | | |
| Number of components | 0/10 | 0/10 |
| having degraded | | |
| capacity (4 mm bend) | | |
| Number of components | 0/10 | 1/10 |
| having degraded | | |
| capacity (5 mm bend) | | |

As shown in Table 4, it can be seen that, in the case of Inventive Example 1, there was no degradation in capacity due to a generation of cracks while the multilayer ceramic electronic components were bent by up to 5 mm, but in the case of Comparative Example 1, a degradation of capacity due to a generation of cracks was observed when the multilayer ceramic electronic component is bent by 5 mm.

FIG. 4 is a graph showing a ratio at which the same multilayer ceramic electronic components (i.e., Comparative Example 1 and Inventive Example 1) as those in Table 4 are degraded in terms of capacity according to a generation of cracks while a degree of bending is continuously changed. In the case of Comparative Example 1, cracks were generated first when the multilayer ceramic electronic component was bent by 4.8 mm to be degraded in capacity, while in the case of Inventive Example 1, capacity was t degraded first when the multilayer ceramic electronic component was bent by 8.4 mm, and it can be seen that an average value of bending depths causing a capacity degradation is considerably greater in the case of the Inventive Example 1 as compared to the case of the Comparative Example 1.

Thus, it can be confirmed from Table 4 and FIG. 4, that the bending strength characteristics of the multilayer ceramic electronic component was enhanced when the spherical cross-linked polymer 1 is added to the conductive resin layers 31b and 32b.

As set forth above, according to the embodiments of the present invention, a paste for an external electrode capable of improving bending strength characteristics of a multilayer ceramic electronic component, a multilayer ceramic electronic component manufactured by using the same, and a manufacturing method thereof can be provided.

While the present invention has been shown and described in connection with the embodiments, it will be apparent to those skilled in the art that modifications and variations can be made without departing from the spirit and scope of the invention as defined by the appended claims.

What is claimed is:

1. A conductive paste for an external electrode, the conductive paste comprising:
100 parts by weight of a conductive metal particle;
5 to 30 parts by weight of a base resin; and
0.5 to 10 parts by weight of a spherical cross-linked polymer.

2. The conductive paste of claim 1, wherein the spherical cross-linked polymer has an average particle diameter ranging from 0.05 μm to 50 μm.

3. The conductive paste of claim 1, wherein the spherical cross-linked polymer has heat resistance at a temperature of 250° C. or higher.

4. The conductive paste of claim 1, wherein the spherical cross-linked polymer has elasticity.

5. The conductive paste of claim 1, wherein the spherical cross-linked polymer includes one or more selected from a group consisting of rubber, polysterene, acryl, silicon, and epoxy.

6. The conductive paste of claim 1, wherein the conductive metal particle includes one or more selected from a group consisting of copper (Cu), nickel (Ni), silver (Ag), and silver-palladium (Ag—Pd).

7. A multilayer ceramic electronic component comprising:
a ceramic body including a dielectric layer;
first and second internal electrodes disposed to face each other within the ceramic body, while having the dielectric layer interposed therebetween;
a first electrode layer electrically connected to the first internal electrode and a second electrode layer electrically connected to the second internal electrode; and
a first conductive resin layer formed on the first electrode layer, and a second conductive resin layer formed on the second electrode layer,
wherein the first and second conductive resin layers include 100 parts by weight of a conductive metal particle; 5 to 30 parts by weight of a base resin; and 0.5 to 10 parts by weight of a spherical cross-linked polymer.

8. The multilayer ceramic electronic component of claim 7, wherein the spherical cross-linked polymer has an average particle diameter ranging from 0.05 μm to 50 μm.

9. The multilayer ceramic electronic component of claim 7, wherein the spherical cross-linked polymer has an average particle diameter ranging from 0.05 μm to a distance equal to half of a thickness of the respective conductive resin layers.

10. The multilayer ceramic electronic component of claim 9, wherein the thickness of the respective conductive resin layers ranges from 3 μm to 100 μm.

11. The multilayer ceramic electronic component of claim 7, wherein the spherical cross-linked polymer has heat resistance at 250° C. or higher.

12. The multilayer ceramic electronic component of claim 7, wherein the spherical cross-linked polymer has elasticity.

13. The multilayer ceramic electronic component of claim 7, wherein the spherical cross-linked polymer includes one or more selected from the group consisting of rubber, polysterene, acryl, silicon, and epoxy.

14. The multilayer ceramic electronic component of claim 7, wherein the conductive metal particle includes one or more selected from a group consisting of copper (Cu), nickel (Ni), silver (Ag), and silver-palladium (Ag—Pd).

15. A multilayer ceramic electronic component comprising:
a ceramic body including a dielectric layer and internal electrodes;
electrode layers electrically connected to the internal electrodes; and
conductive resin layers formed on the electrode layers, respectively, and including 100 parts by weight of a conductive metal particle; 5 to 30 parts by weight of a base resin; and 0.5 to 10 parts by weight of a spherical cross-linked polymer,
wherein the spherical cross-linked polymer has an average particle diameter ranging from 0.05 μm to a distance equal to half of a thickness of the respective conductive resin layers, and the thickness of the respective conductive resin layers ranges from 3 μm to 100 μm.

16. A method of manufacturing a multilayer ceramic electronic component, the method comprising:
preparing a ceramic body including a dielectric layer and first and second internal electrodes disposed to face each other, while having the dielectric layer interposed therebetween;
forming first and second electrode layers such that the first and second electrode layers are electrically connected to the first and second internal electrodes;
hardening a crosslinkable material to prepare a spherical cross-linked polymer;
mixing 100 parts by weight of a conductive metal particle; 5 to 30 parts by weight of a base resin; and 0.5 to 10 parts by weight of a spherical cross-linked polymer to prepare a conductive paste for an external electrode; and
applying the conductive paste for an external electrode to the first and second electrode layers and hardening the paste to form first and second conductive resin layers.

17. The method of claim 16, wherein the spherical cross-linked polymer has an average particle diameter ranging from 0.05 μm to 50 μm.

18. The method of claim 16, wherein the spherical cross-linked polymer has heat resistance at a temperature of 250° C. or higher.
